(19) United States
(12) Patent Application Publication
(10) Pub. No.: US 2007/0058532 A1
(43) Pub. Date: Mar. 15, 2007

(54) System and method for managing network congestion

(76) Inventors: Manoj Wadekar, San Jose, CA (US); Gary McAlpine, Banks, OR (US); Tanmay Gupta, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/227,897

(22) Filed: Sep. 15, 2005

(51) Int. Cl. H04L 12/26

(52) U.S. Cl. 370/229; 370/521

(57) ABSTRACT

According to one embodiment of the invention, a method comprises measuring traffic congestion experienced by a message transmitted from a source device, and if the measured traffic congestion exceeds a threshold limit, altering at least one bit within a Layer 2 (L2) header of the message. This bit alteration is subsequently used to determine when to notify a source of the message that the message experienced traffic congestion.

### FIELD

Embodiments of the invention relate to the field of networking, in particular, to a system and method for managing congestion over an Open Systems Interconnection (OSI) Layer 2 (L2) network.

### GENERAL BACKGROUND

Over the last year or so, Ethernet is now being considered as a viable solution for blade server backplanes and datacenter networks (generally referred to as “localized data networks”). Typical datacenter networks multiple network connections; e.g. Storage traffic, inter-processor communication (IPC) traffic and local area network traffic. All of these different traffic types need different infrastructure. For example, storage traffic needs servers and storage discs to have Fiber Channel adaptors and Fiber channel switches to connect them. IPC traffic needs high performance networking infrastructure. LAN traffic is carried over Ethernet infrastructure. It will be greatly beneficial (from cost and management perspective), if all these traffic types are carried over single networking infrastructure: Ethernet.

However, one major hurdle in adopting this solution is that many Ethernet network implementations have rudimentary traffic controls, and thus, high latencies may be experienced for data communications within Ethernet networks. In order to achieve an acceptable level of data throughput and reduce latencies experienced over localized data networks, traffic congestion, such as increased packet queuing or dropped packets, needs to be quickly detected.

Currently, router-based Ethernet networks have adapted a mechanism to detect and handle OSI Layer 3 (L3) traffic congestion. This mechanism is referred to as Explicit Congestion Notification or “ECN”. More specifically, for ECN, traffic congestion is detected by accessing a specific bit or group of bits within an Internet Protocol (IP) header of an incoming IP message received by the router as described below.

As shown in FIG. 1, each IP message 100 from a source device 150 includes an IP header 110 and a payload 140. IP header 110 comprises an ECN sub-field 130, such as a sixth and seventh bit 125 of a Type of Service (ToS) field 120. Upon detecting an unsuitable amount of traffic congestion, a router 160 sets ECN sub-field 130 to represent a Congestion Experienced (CE) condition (ToS[7:6]=[1,1]), namely setting the CE bit (ToS[7]=1). This setting denotes L3 traffic congestion, which is subsequently detected by a destination device 170 upon receiving the IP message 100 and reported back to source device 150 by Transport Control Protocol (TCP).

In summary, this TCP/IP flow control typically uses Congestion Window adaptation to estimate available bandwidth (BW) in the data network and adjusts the transmission rate accordingly. In other words, the transmission rate may be decreased to ease TCP/IP traffic. The Congestion Window is changed by using (1) packet drops assumed due to timeout, (2) duplicate acknowledgement (ACK) messages, and (3) ECN as described above. While ECN provides a good mechanism for detecting L3 congestion of data flow, it does not consider L2 congestion since ECN is configured so that only IP applications are congestion aware. Non-IP mechanisms have no visibility into congestion experienced by L2 networks.

As a result, since the typical topology for localized data networks such as blade server and datacenter networks involve an interconnection of servers by L2 switches, ECN would not be able to report and handle traffic congestion.

### BRIEF DESCRIPTION OF THE DRAWINGS

The invention may best be understood by referring to the following description and accompanying drawings that are used to illustrate embodiments of the invention.

FIG. 1 is a block diagram of a conventional ECN congestion control mechanism.

FIG. 2 is an exemplary diagram of a system implemented with a congestion control mechanism according to one aspect of the invention.

FIG. 3 is an exemplary embodiment of a data structure for a L2 header of a frame encapsulated within a message transmitted from one networking device to another and intercepted by a switch.

FIG. 4 is an exemplary embodiment of a data structure for a TCP header of an Acknowledgement (ACK) message from one networking device to another.

FIG. 5 is another exemplary diagram of a system implemented with a congestion control mechanism according to one aspect of the invention.

FIG. 6 is an exemplary embodiment of a flowchart illustrating a congestion control mechanism set forth in FIGS. 2 and 5.

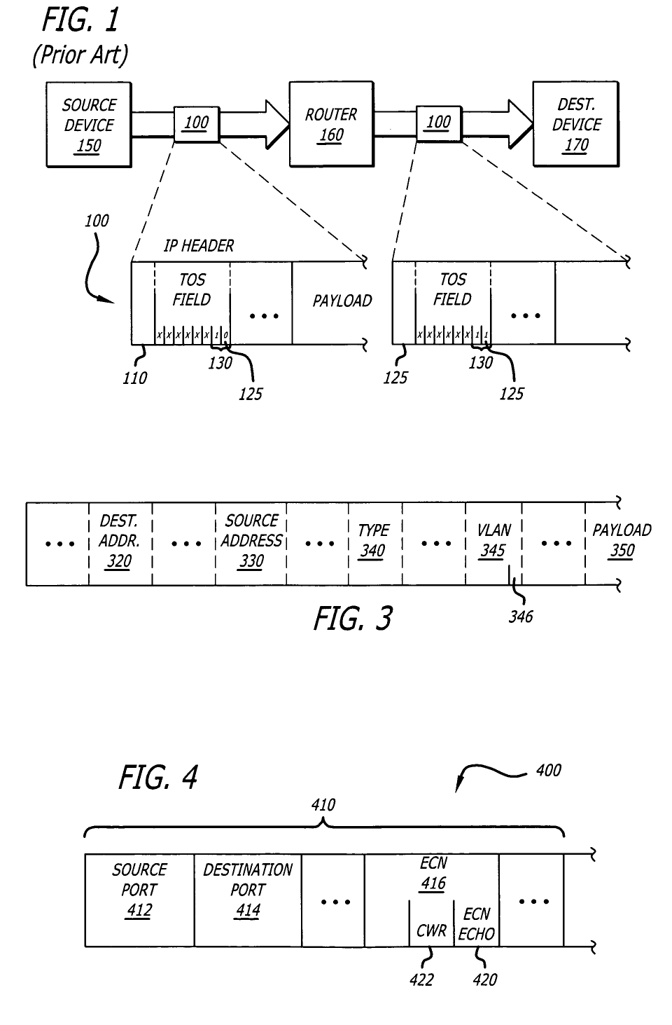

### DETAILED DESCRIPTION

Herein, certain embodiments of the invention relate to a system and method for managing congestion caused by Internet Protocol (IP) messages or non-IP messages over a network. This congestion management mechanism is adapted to detect and handle traffic congestion associated with Open Systems Interconnection (OSI) Layer 2 (L2) networks. According to one embodiment of the invention, a Congestion Indication (CI) parameter is set within L2 frames transmitted over the network. The CI parameter is set by L2 switches/devices that experience congestion, such as congestion due to oversubscription for example. The CI parameter may be implemented as one or more bits within an L2 header (e.g., MAC header) of a message received by the L2 switch.

In the event that, at the destination (networking) device, the OSI Network Layer internetworking protocol is “IP” and, when the CI parameter is set, the IP layer should pass this information to a corresponding OSI Transport Layer such as “Transport Control Process” (TCP) or “User Datagram Protocol” (UDP). For instance, with respect to the TCP configuration, TCP will behave as if it has received an indication that the CE bit has been set and send an acknowledgement (ACK) message with an ECN-Echo bit set to the source (networking) device. The remaining operations will follow ECN specification.

In the event that, at the destination (networking) device, the OSI Network Layer internetworking protocol is “Non-IP” and, when the CI parameter is set, this “Non-IP” layer can define extension to its protocol to carry this congestion information back to the source (networking device) device. This source device then should ensure reduction of its rate of information transmission towards the destination (networking device). This will help in reducing the congestion in the intermediate device(s).

In the following description, certain terminology is used to describe features of the invention. For example, the term “networking device” is any device supporting access to a network via a link, which includes and is not limited or restricted to a computer such as any type of server (e.g., blade server), a network interface card or the like. A “switching device” includes a device adapted to transfer information, such as a L2 switch. A “link” is generally defined as an information-carrying medium that establishes a communication pathway. The link may be a wired interconnect, where the medium is a physical medium (e.g., electrical wire, optical fiber, cable, bus traces, etc.) or a wireless interconnect (e.g., air in combination with wireless signaling technology).

A “message” is broadly defined as information placed in a predetermined format for transmission over a network from a source device. The message may be in a variety of formats such as an Ethernet frame configured in accordance with current or future Ethernet standards such as the IEEE 802.3 standard entitled “Carrier Sense Multiple Access with Collision Detection (CSMA/CD) Access Method and Physical Layer Specifications” (2002), a packet encapsulated as an IP packet and including an Ethernet frame, or the like. The “source device” is broadly defined as a sender of a message while a “destination device” is the intended recipient of the message. Both source and destination devices may be networking devices.

The term “logic” is generally defined as hardware and/or software that perform one or more operations such as measuring data traffic and setting data within a transmitted frame to denote traffic congestion. When deployed in software, such software may be executable code such as an application, a routine or even one or more instructions. Software may be stored in any type of memory, namely suitable storage medium such as a programmable electronic circuit, any type of semiconductor memory device such as a volatile memory (e.g., random access memory, etc.) or non-volatile memory (e.g., read-only memory, flash memory, etc.), a hard drive disk, or any portable storage such as a floppy diskette, an optical disk (e.g., compact disk or digital versatile disc “DVD”), a digital tape or the like.

As an example, a storage medium may be provided to store software that, if executed by a switching device such as an L2 switch, will cause the switching device to (i) measure traffic at incoming and outgoing ports of the switching device, and (ii) alter information within the L2 header of an incoming message prior to outputting the message in order to indicate traffic congestion where the measured traffic congestion exceeds a threshold limit. The information is used to initiate a mechanism, such as an established ECN notification scheme, for notifying a source of the message as to the traffic congestion experienced by the message. The alteration may involve setting a bit, such as a Canonical Format Identifier (CFI) bit, within an Ethernet message or creating a new header in the Ethernet frame to carry this CI bit or setting a value within a Type of Service (ToS) field of the Ethernet message.

In the following description, numerous specific details are set forth. However, it is understood that embodiments of the invention may be practiced without these specific details. In other instances, well-known circuits, structures and techniques have not been shown in detail in order not to obscure the understanding of this description.

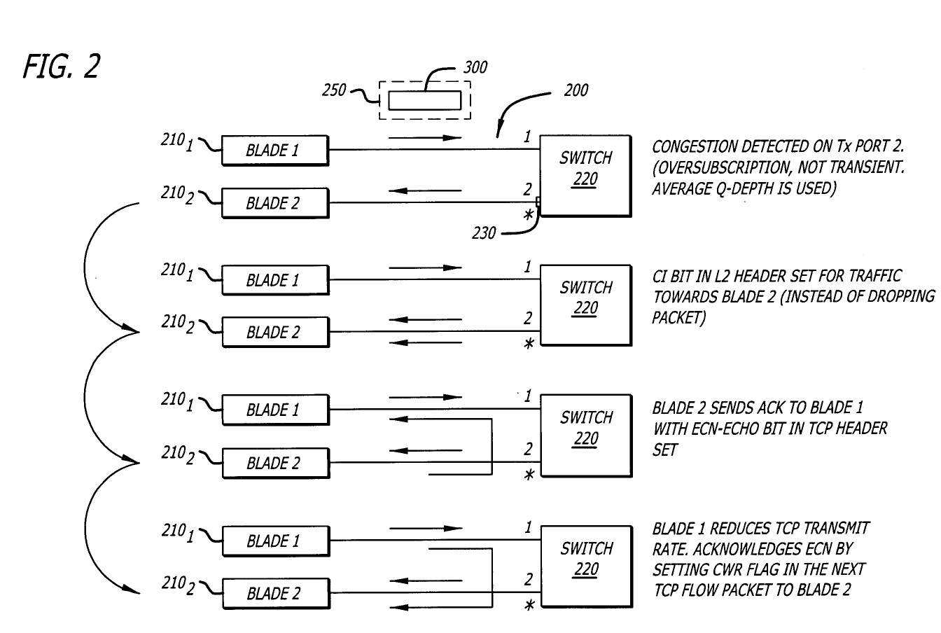

Referring to FIG. 2, an exemplary data flow diagram of a system 200 implemented with a congestion control mechanism according to one aspect of the invention. System 200 operates as a localized data network such as a blade server network or a datacenter network. System 200 comprises a plurality of networking devices 210₁-210_{N} (N≧2), such as blade servers in this embodiment of the invention, in communication with a switch 220. Blade servers 210₁ and 210₂ are in communication over a backplane and housed within the same computer housing (not shown).

As shown, blade server 210₁ transmits a message 250 to blade server 210₂. A frame 300 (e.g., Ethernet frame) is encapsulated within message 250 and includes an L2 header 310 and a payload 350 as shown in FIG. 3. According to one embodiment of the invention, L2 header 310 comprises a destination address 320, a source address 330, and information associated with a TYPE field 340 and a virtual local area network (VLAN) field 345.

Upon detecting congestion on a port 230 (e.g., TX port 2), switch 220 may be adapted to set TYPE field 340 of FIG. 3 to a particular value to identify that frame 300 has experienced unacceptable traffic congestion. This constitutes a setting of a Congestion Indication (CI) parameter. Alternatively, as another illustrated example, any unused bit within the L2 (or MAC) header 310 of frame 300 may be used as the CI parameter. For instance, according to one embodiment of the invention, a Canonical Format Identifier (CFI) bit 346 within VLAN field 345 of frame 300 may be used as the CI parameter to support Ethernet-based communications within system 200.

Regardless whether the CI parameter is set by the switch altering TYPE field 340 or any unused bit in L2 header 310 (e.g., CFI bit 346 of VLAN field 345), message 250 including the altered Ethernet frame 300 is routed to blade server 210₂ through congested port 230. Blade server 210₂ is adapted to monitor incoming Ethernet frames to detect the setting of the CI parameter to denote unacceptable traffic congestion.

Upon detecting the CI parameter being set, the OSI Link layer of blade server 210₂ notifies its OSI Network layer that the CI parameter is set. For instance, the IP layer would be notified and pass this information to a corresponding OSI Transport Layer such as “Transport Control Process” (TCP) or “User Datagram Protocol” (UDP). For instance, with respect to TCP implementation, TCP would send an acknowledgement (ACK) message 400 back to blade server 210₁ with an ECN-Echo bit set 420 within a TCP header 410 of ACK message 400.

As shown in FIG. 4, ACK message 400 includes a TCP header 410 that comprises a plurality of fields including a source port 412, destination port 414, and most pertinent to the subject application, an ECN field 416. ECN field 416 comprises three bits, of which ECN-ECHO bit 420 indicates that traffic congestion was experienced by the message whose receipt is being acknowledged. ECN field 416 further comprises a congestion window reduced (CWR) flag 422 that, when set by blade server 210₁, indicates receipt of ACK message 400 and signals that reduction in transmit rate or routing alteration has been conducted by blade server 210, to reduce traffic congestion on port 230 of switch 220.

In summary, blade server 210₂ notifies that it has received a message experiencing traffic congestion and sends ACK message 400 to blade server 210, with the ECN-ECHO bit 420 being set in TCP header 410. The setting of ECN-ECHO bit 420 informs blade server 210₁ that message 250 experienced traffic congestion, and thus, blade server 210, can adjust the TCP transmit rate or path to reduce such data traffic congestion. Optionally, blade server 210₁ may return an ACK message to blade server 210₂ to acknowledge receive of the ECN by setting the CWR flag 422 in the next TCP flow packet to blade server 210₂.

The above-described invention is advantageous because it enhances the current ECN mechanism to be an application in a backplane, datacenter or cluster network configuration. Further, it allows TCP to adjust to congestion within L2 clusters so that Head of Line (HoL) blocking can be avoided, while improving throughput and enabling traffic congestion monitoring of non-IP messages. This further allows “Non-IP” protocols aware of congestion in the intermediate devices enabling them to implement better and newer congestion management protocols/techniques.

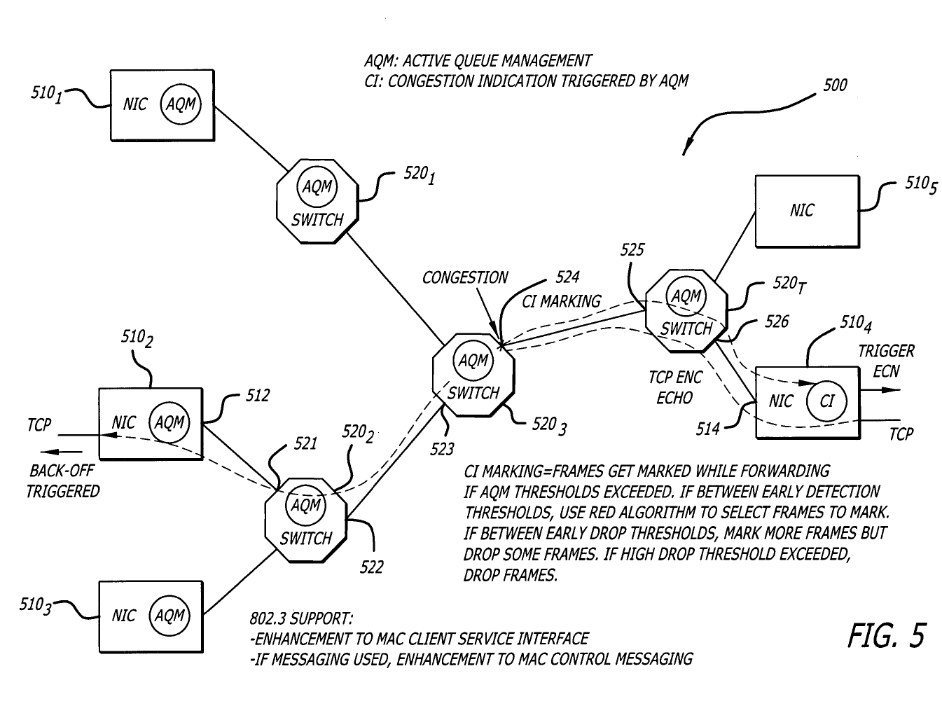

Referring now to FIG. 5, another exemplary diagram of a system implemented with a congestion control mechanism according to one aspect of the invention is shown. As shown, system 500 operates as a network with a plurality of networking devices 510₁-510ₛ (S≧2), such as Network Interface Cards “NICs,” in communication with each other using one or more switches 520₁-520_{T} (T≧2). Most of networking devices 510₁-510ₛ and switches 520₁-520_{T} are implemented with logic, referred to as Active Queue Management (AQM), to determine unacceptable traffic congestion experienced in data flows between these devices.

In general, AQM is a mechanism using one of several alternatives for congestion indication, but in the absence of ECN, AQM is restricted to using packet drops as a mechanism for congestion indication. AQM drops packets based on the average queue length exceeding a threshold, rather than only when the queue actually overflows.

For ECN, AQM can set a Congestion Experienced (CE) codepoint in the IP header instead of dropping the packet. Similarly, AQM may be adapted to identify congestion such as at port 530 of switch 520₃.

For this illustrative example, networking device 510₂ is transferring an Ethernet message to networking device 510₄. The message is routed through port 512 of networking device 510₂, ports 521-522 of switch 520₂, ports 523-524 of switch 520₃, ports 525-526 of switch 520₄ and port 514 of networking device 510₄. AQM of switch 520₃ detects congestion at port 524 and sets the CI parameter. This may be accomplished by setting the CFI bit within the VLAN field of the Ethernet frame according to one embodiment of the invention. Of course, it is possible that a new field can be defined in the L2 header of Ethernet frame to carry this congestion information. The Ethernet frame may be the Ethernet message itself or encapsulated within the Ethernet message.

Networking device 510₄ detects congestion and responds by setting the ECN-ECHO bit within the TCP header of an Acknowledgement returned to networking device 510₂. Hence, non-IP messages and L2 congestion can be detected in lieu of restricting traffic congestion only for L3 traffic.

Upon AQM detecting unacceptable traffic conditions, the outgoing frames get marked. Random Early Detection (RED) algorithm may be used to select frames to mark. Such marking involves setting the CI parameter and forwarding of the message to the destination device. The procedure for handling through translation of the CI parameter to cause the setting of the ECN-Echo bit of the TCP header in a returned ACK message is describe above.

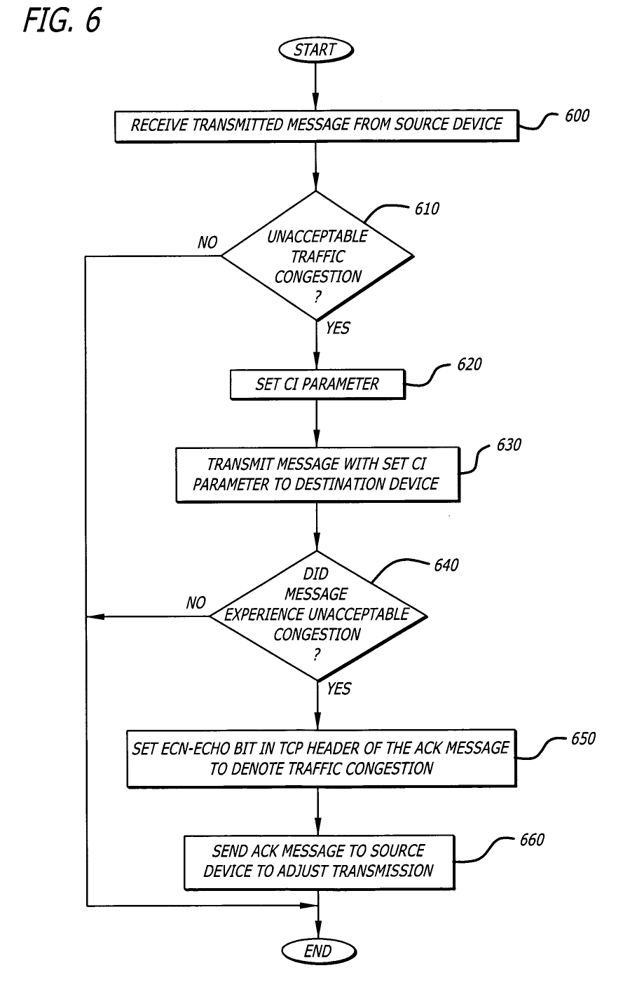

Referring now to FIG. 6, an exemplary embodiment of a flowchart illustrating a congestion control mechanism set forth in FIGS. 2 and 5 is shown. First, a traffic condition is detected for a transmitted message that is beyond an acceptable threshold (blocks 600 and 610). Upon detecting such a condition, a Congestion Indication (CI) parameter is set in the L2 header of the message (block 620). The message may be an Ethernet frame, perhaps encapsulated within an IP message. The CI parameter may be set by a variety of mechanisms such as setting an unused bit in the L2 header (e.g., CFI bit), setting bit in a new field defined in the L2 header of Ethernet frame, setting the value within the Type field of the frame to identify a frame experiencing unacceptable traffic conditions, and the like.

Thereafter, the message is routed to the destination device, which determines that the frame experienced unacceptable traffic congestion (blocks 630 and 640). This is determined through analysis of the CFI bit for example, or the value placed in the Type field of the frame. Information regarding the presence of unacceptable traffic congestion is provided to the source device through an Acknowledgement (ACK) message from the destination device (block 650). Such presence may be identified to the source device by setting the ECN-ECHO bit within the ECN field of the TCP header.

The information is returned to the source device to adjust transmit rates, transmission paths and the like (block 660).

While the invention has been described in terms of several embodiments of the invention, those of ordinary skill in the art will recognize that the invention is not limited to the embodiments of the invention described, but can be practiced with modification and alteration within the spirit and scope of the appended claims. The description is thus to be regarded as illustrative instead of limiting. For instance, the ACK message may be from another Network Layer other than TCP as described above.

What is claimed is:

1. A method comprising:
measuring traffic congestion experienced by a message transmitted from a source device; and
altering at least one bit within a Layer 2 (L2) header of the message if the measured traffic congestion exceeds a threshold limit.

2. The method of claim 1, further comprising:
transmitting the message with the altered L2 header to a destination device; and
notifying the source device that the measured traffic congestion exceeds the threshold limit.

3. The method of claim 1, wherein the altering of the at least one bit includes setting a Canonical Format Identifier (CFI) bit within a virtual local area network (VLAN) field of an Ethernet frame operating as the message.

4. The method of claim 1, wherein the altering of the at least one bit includes setting a bit in a newly defined field in the L2 header of an Ethernet frame operating as the message.

5. The method of claim 1, wherein the altering of the at least one bit includes setting a value within a Type of Service (ToS) field of an Ethernet frame operating as the message to identify that the message experienced traffic congestion exceeding the threshold limit.

6. The method of claim 2, wherein the notifying of the source device includes generating an Acknowledgement (ACK) message including a Transmission Control Protocol (TCP) header, setting an ECN-Echo bit of the ACK message and transferring the ACK message to the source device.

7. The method of claim 6 further comprising:
transmitting a second Acknowledgement (ACK) message from the source to the destination, the second ACK message including a congestion window reduction (CWR) flag being set to denote that the source device has taken actions to reduce the traffic congestion.

8. A switching device comprising:
a first logic to measure traffic congestion associated with ports of the switch;
a second logic to alter at least one bit within a Layer 2 (L2) header of an incoming message prior to outputting the message in order to identify traffic congestion exceeding a threshold limit, the altered L2 header of the message indicating to a destination device targeted to receive the message of the traffic congestion and causing the destination device to notify a source device of the message.

9. The switching device of claim 8, wherein the second logic to alter the at least one bit of the L2 header by setting a Canonical Format Identifier (CFI) bit within a virtual local area network (VLAN) field of an Ethernet frame encapsulated within the message.

10. The switching device of claim 8, wherein the second logic to alter the at least one bit of the L2 header by setting a Canonical Format Identifier (CFI) bit within a virtual local area network (VLAN) field of an Ethernet frame being the message.

11. The switching device of claim 9, wherein the first logic and the second logic are software modules.

12. The switching device of claim 8, wherein the second logic, being a software module, to alter the at least one bit of the L2 header by setting a value within a Type of Service (ToS) field of an Ethernet frame being at least a portion of the message, the altered L2 header to identify that the message experienced traffic congestion.

13. A storage medium that provides software that, if executed by a switching device, will cause the switching device to perform the following operations:
measure traffic at incoming and outgoing ports; and
alter information within a Layer 2 (L2) header of an incoming message prior to outputting the message in order to indicate traffic congestion where the measured traffic congestion exceeds a threshold limit, the information being used for notification of a source of the message as to traffic congestion experienced by the message.

14. The storage medium of claim 13, wherein the software includes a software module to set at least one bit within the L2 header of the incoming message to indicate traffic congestion.

15. The storage medium of claim 14, wherein the software includes a software module to set a Canonical Format Identifier (CFI) bit within a virtual local area network (VLAN) field of the incoming message being an Ethernet frame.

16. The storage medium of claim 14, wherein the software includes a software module to set a value within a Type of Service (ToS) field within the incoming message being an Ethernet frame.

17. A system comprising:
a first networking device;
a second networking device; and
a switch to receive an Ethernet message from the first networking device for transmission to the second networking device, the switch to altering at least one bit within a Layer 2 (L2) header of the Ethernet message prior to transmission to the second networking device in response to detecting traffic congestion exceeding a threshold limit.

18. The system of claim 17, wherein the switch to set a Canonical Format Identifier (CFI) bit within a virtual local area network (VLAN) field of the Ethernet message.

19. The system of claim 18, wherein the switch to set the CFI bit within the Ethernet message that is encapsulated within an Internet Protocol (IP) message.

20. The system of claim 17, wherein the switch to set a value within a Type of Service (ToS) field of the Ethernet message to indicate that the message experienced traffic congestion.
